(19) United States
(12) Patent Application Publication
(10) Pub. No.: US 2012/0031824 A1
(43) Pub. Date: Feb. 9, 2012

(54) MODULE INSERT FOR INSTALLATION IN A LIQUID FILTER

(76) Inventors: Michael Braunheim, Goppingen (DE); Matthias Gänswein, Esslingen (DE); Jörg Hrodek, Mittlern (AT); Richard Wlassa, Stuttgart (DE); Sven Siegle, Winnenden (DE)

(21) Appl. No.: 13/055,831

(22) PCT Filed: Jul. 17, 2009
(86) PCT No.: PCT/EP2009/059246

§ 371 Date: Sep. 23, 2011

(30) Foreign Application Priority Data
Jul. 26, 2008 (DE) 10 2008 034 901.1

(51) Int. Cl. B01D 15/00; B01D 35/18; B01D 27/00

(52) U.S. Cl. 210/185; 210/435; 210/418; 210/287

(57) ABSTRACT

A module insert includes at least one water level sensor, at least one valve, at least one flow channel for water, and at least one reservoir with a sorbent mechanism. The sorbent mechanism is configured to absorb impurities from the separated water and is disposed in the reservoir. The sorbent mechanism is further configured to extend a dwell time of the separated water in the module insert.

The present invention relates to a module insert for installation in a liquid filter for cleaning the water separated out, in particular for installation in a fuel filter.

U.S. Pat. No. 5,501,723 discloses a filter with active carbon for cleaning the waste air from a fuel tank of a motor vehicle. To clean the air over the fuel in the tank, a filter with active carbon is inserted into a waste air channel. To increase the cleaning efficiency, the filter is configured with different successive chambers, through which the waste air must flow. Active carbon is contained in each chamber.

DE 10 2006 039 581 discloses a fuel filter in which a further filter for cleaning the water separated out is attached to the filter housing and has active carbon as the further filter material. The question of how the filter containing the active carbon is configured remains open, however.

The object of the present invention is to improve a known fuel filter by means of a module insert for installation in the same, in that the module insert contains a compact and efficient additional filter.

This problem is solved according to the invention by the subject matter of the independent claims. Advantageous embodiments form the subject matter of the dependent claims.

The invention is based on the general idea of providing a module insert for installation in a fuel filter for cleaning the water separated out, which module insert has a reservoir with sorbent means for absorbing impurities from the water separated out, which means are arranged in the reservoir in such a manner that the longest possible dwell time of the water in the region of the sorbent means can be achieved. A particularly high cleaning level of the water separated out can be achieved thereby.

Further important features and advantages of the invention can be found in the subclaims, the drawings and the associated description of the figures using the drawings.

It is self-evident that the features which are mentioned above and those which are still to be explained below can be used not only in the combination specified in each case, but also in other combinations or alone without departing from the scope of the present invention.

Preferred exemplary embodiments of the invention are shown in the drawings and are explained in more detail in the following description, with the same reference symbols referring to the same or similar or functionally identical components.

In the figures,

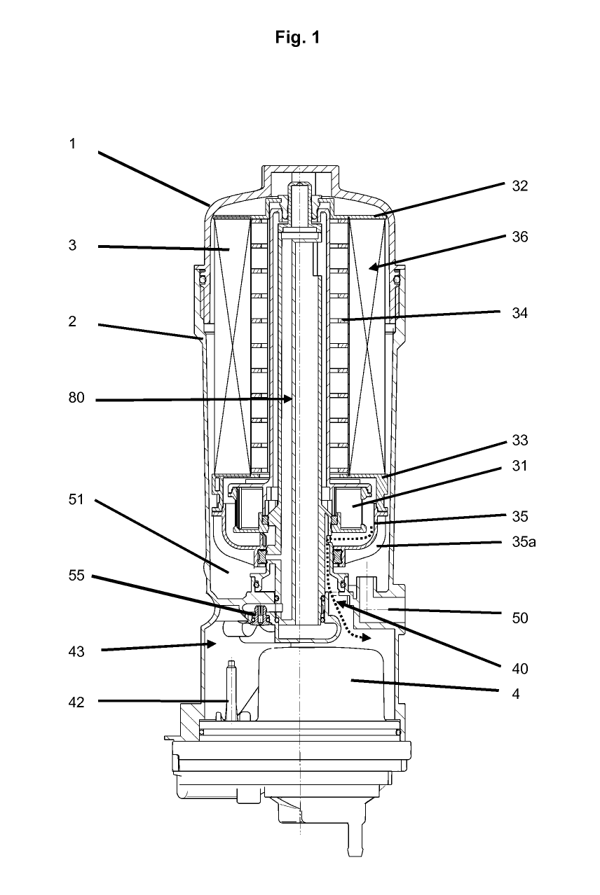

FIG. 1 shows a longitudinal section through a fuel filter according to the invention,

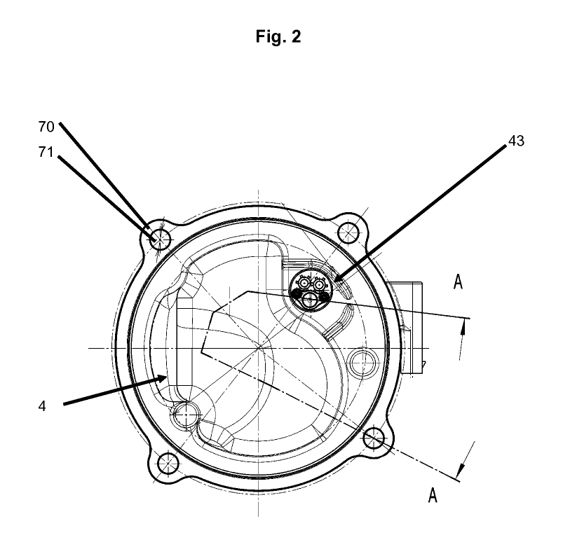

FIG. 2 shows a plan view of the module insert,

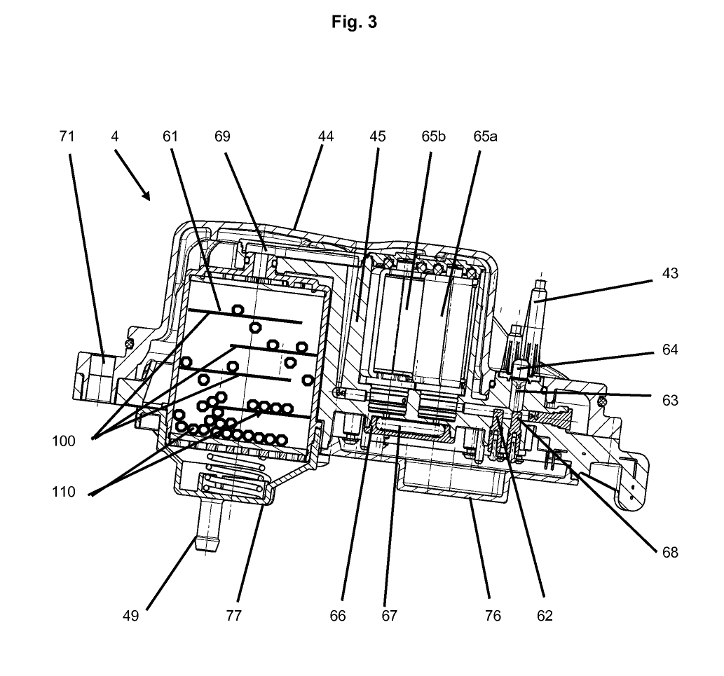

FIG. 3 shows a section along line A-A of FIG. 2 of the module insert,

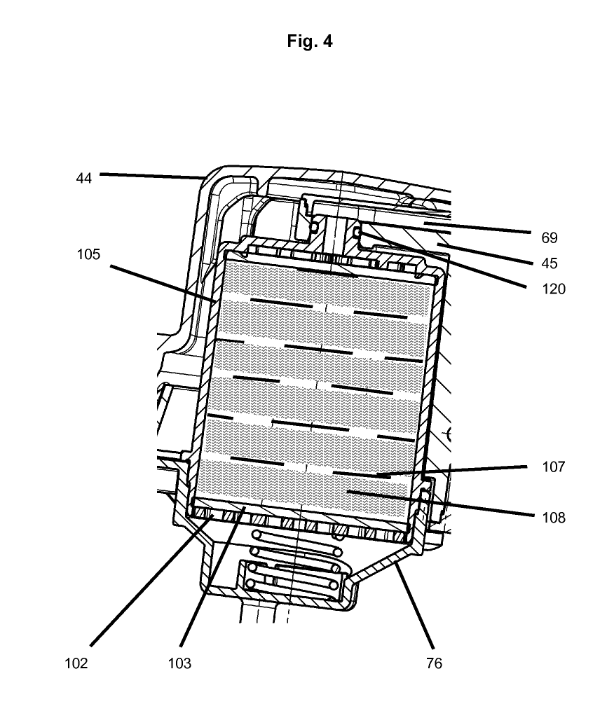

FIG. 4 shows a detail of FIG. 3,

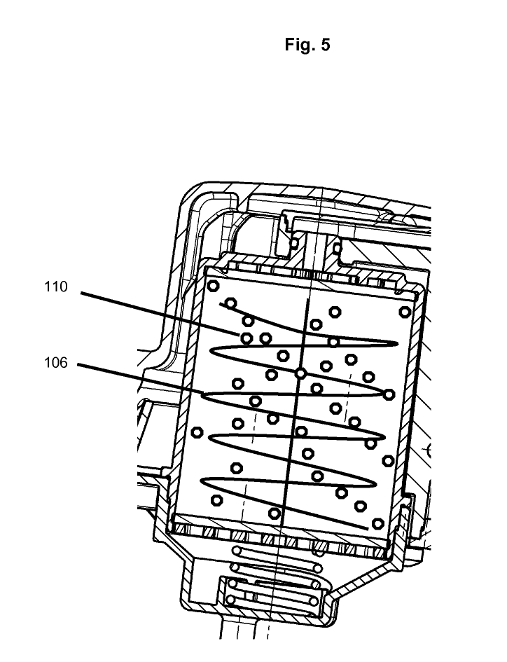

FIG. 5 shows a detail of FIG. 3 in a different embodiment.

FIG. 1 shows a complete fuel filter according to the invention in longitudinal section. A filter housing 2, which accommodates a filter element 3 and a module insert 4, is closed from above with a lid 1. Under this there is a filter chamber 51 in which the fuel is cleaned of suspended particles by means of the filter element 3. There is also a precleaning means for coarser particles, but this is not shown here. The detailed structure of the filter element 3 is shown for example in FIGS. 4 and 5. The filter element 3 consists of a cylindrical inner frame 34, on which the special paper sits as the filter 36, as well as of an upper end disc 32 and a lower end disc 33, a base 35 with outer ribs 35a and a basket-shaped screen 31. When the fuel filter is assembled, this replaceable filter element 3 is pushed over the functional carrier 80 which is attached fixedly in the filter housing 2 and conducts the media water and fuel. The filter element 3 contains as the filter special paper or other materials; the water present in the fuel can coalesce here. It then flows as tiny droplets with the fuel to the screen 31. The fuel passes through this screen 31 to the clean side and exits the fuel filter via the functional carrier 80 and corresponding outlets (not shown). The basket-shaped screen 31 is formed from a lipophilic material in such a manner that the water droplets already present enlarge further and are then transported downwards by gravity into the water collection chamber 43. The smaller the amount of suspended material in the fuel, the lower the fuel fraction in the water separated out, therefore the water is separated out on the clean side of the filter element 3. The module insert 4 is inserted from below into the filter housing 2 in the water collection chamber 43 and screwed fast or otherwise fixed.

The path of the water is shown as an arrow 40. The inlet for the fuel is labelled with reference symbol 50; the fuel passes from here into the fuel distribution chamber 51 and is pushed through the filter element 3 by the high pressure of approximately 5-10 bar in the fuel system. These high pressures with pressure peaks of over 20 bar are also present in the water collection chamber 43. As the interior of the module insert 4 is not pressure-stable, it is protected by a pressure-stable housing 44. The water level sensor 42 in the water collection chamber 43 ensures that the water is drained into the module insert 4 when it reaches a predefined height. The water remains in the water collection chamber 43 for some time, the fuel fraction still present can thereby collect over the standing water. This fuel fraction is extracted via the throttle or valve 55 which is situated in the functional carrier 80 and then flows back into the fuel tank.

The flow of the water can be influenced in the water collection chamber 43 by the outer shape of the pressure-stable housing 44, in that for example calming zones are created by projections in the water collection chamber 43 (not shown).

FIG. 2 shows a plan view of the module insert 4. To be able to accommodate at least one water level sensor 42, the pressure-stable housing 44 differs from the circular shape. The module insert 4 can be fixed to the filter housing 2 by means of openings 71 in the indentations 70, for example by means of screw fastenings. The module insert 4 has a multi-part structure, the base 73 being fixed to the pressure-stable housing 44 for example by screw fastenings 72 or the like. The seal 74 is used to seal off from the filter housing 2. The purified and now clean water is drained into the environment via the outlet 49.

FIG. 3 shows the interior of the module insert 4 along section A-A from FIG. 2. The water which has separated out of the fuel and collected in the water collection chamber 43, takes the following path when the water level sensors 42 open the valves 65a and 65b, for example solenoid valves. The water first flows through a small screen 64 in the flow channel 63 in which further sensors 68 are situated; the two valves 65a and 65b are attached to the flow channel 63. A displacer element 67 lies in the flow channel 66 between the valves 65a and 65b, which displacer element is intended to prevent the water from freezing, see DE 10 2007 054 770 which is hereby incorporated by reference. The water then passes via the flow channel 69 into the reservoir 61 which is configured as a cleaning cartridge and therefore can be replaced. Different materials can be present in the reservoir 61 which absorb the remnants of fuel which are still contained in the water separated out.

The reservoir 61 can contain active carbon and a fuel-absorbing woven or nonwoven fabric, textile carpet or similar as the sorbent. Even the material of the reservoir 61 itself can consist of sorbent material which swells due to the absorption of fuel and thus removes the remaining fuel from the water separated out. The aim is that the water separated out contains only approximately 2 ppm of fuel residue; this proportion is considered safe for the environment. According to the invention, the sorbent means are arranged in the reservoir 61 in such a manner that a dwell time of the water separated out in the module insert 4 is extended, as a result of which a particularly high cleaning level can be achieved.

The module insert 4 is composed of the pressure-stable housing 44 and an inner part 45 in which the channels 63, 66 and 69 are arranged. The module insert 4 is closed from below with a base 76 which is connected fixedly to the inner part 45 and a lower lid 77 which should make it possible to change the reservoir 61. Alternatively, the lower lid 77 can also be connected fixedly, for example by welding, to the inner part 45 and pressure-stable housing 44.

The water-conducting flow channel 69 and the reservoir 61 in the module insert 4 which are situated downstream of the solenoid valves 65a and 65b should idle as slowly as possible to improve the adsorption conditions in the reservoir 61. Optimal adsorption conditions prevail with a certain flow of the water separated out through the reservoir 61; it flows preferably from bottom to top, alternatively it can flow from top to bottom, as shown here. The flow channels 63, 66, 69 necessary for this are provided as required in the inner part 45.

The flow channel 69 downstream of the solenoid valves 65a/b is pressureless with air cushions; this volume reserve is used to absorb volume changes such as during freezing. The pressure-stable housing 44 is therefore also necessary to shield this region from pressure in the fuel. The free ventilation of the outlet 49 downstream of the reservoir 61 with the active carbon filter means that the water can drain out of this region and any lines connected downstream (not shown). Furthermore, a ventilation valve can also be present in the flow channel 69 upstream of the reservoir 61, which valve ensures that air can enter and the water drains out of the downstream reservoir 61 and lines. This ventilation valve opens pressurelessly or when there is a vacuum and closes with pressure (not shown).

The further sensors 68 can be a temperature sensor and a heating system for thawing or operation at sub-zero temperatures; the use of the temperature sensor 68 and the associated signal processing should ensure that the solenoid valves 65 are not opened at sub-zero temperatures.

The modular insert 4 has an integrated structure, that is, it contains all the lines for the water separated out of the fuel through the flow channels 63, 66 and 69 integrated in the inner part 45. The module insert 4 has the accommodating geometry for the solenoid valves 65, it integrates the reservoir 61 with the absorber fixedly or replaceably, it has a connection to the power supply, it conducts currents and signals or has installation space for signal processing components. Furthermore, it accommodates the water level sensors 42 for the detection of water, which project into the water collection chamber 43 of the filter housing 2. The solenoid valves 65 are configured in such a manner that the solenoid valves 65 are closed without current. The arrangement of the solenoid valves 65 is such that, at least in one solenoid valve, the fuel pressure pushes the valve closed, and the valve must open against the fuel pressure.

The modular insert 4 has a three-part structure for installation or integration in the fuel filter housing 2. The water collection chamber 43 is formed by the free spaces between the module insert 4 and the filter housing 2. A pressure-stable housing 44 absorbs the forces due to the fuel pressure. The pressure-resistant housing 44 can consist of aluminium or flame-resistant plastics and thereby ensures the tightness of the fuel system for a sufficiently long time, even in the event of a vehicle fire.

So that the dwell time of the water in the reservoir 61 is as long as possible, conducting elements 100 are provided which point away from the outer wall 105. The active carbon granules 110 are situated in the interspaces as shown. The size of the granules shown here is variable according to requirements and should actually only illustrate how the active carbon granules 110 are approximately arranged in the reservoir 61. For the sake of clarity, the whole reservoir 61 in FIG. 3 has not been filled with the active carbon granules, which is of course the case in a real product. The conducting elements 100 must be arranged in the reservoir 61 in such a manner that accelerated drainage of the water due to creep effects cannot occur. There is also the possibility of layering both active carbon granules and active carbon fibres in the reservoir 61. The conducting elements 100 preferably consist of a material which also adsorbs the fuel, just like the outer walls 105 of the reservoir 61.

FIG. 4 shows an enlarged detail of FIG. 3. In this exemplary embodiment a nonwoven or knitted fabric or other fibres 108 are arranged between the conducting elements 107. The conducting elements 107 are not connected to the outer wall 105 but lie loosely between the fibre layers 108. The fibres 108 can consist of active carbon or other fuel-storing materials.

Alternatively, chips can be added to the active carbon granules, which are then arranged randomly and likewise result in an increase of the dwell time of the water in the reservoir 61. These chips could consist of a plastic like the conducting elements 107 so that they also store fuel (not shown).

In all the alternatives presented, neither the active carbon granules nor the conducting elements 105 introduced are so loose that they can be displaced. At the lower end of the reservoir 61 there is a baseplate 102 with holes through which water can drain. It then flows into the lid 76 which closes the reservoir 61 from below and can drain via the outlet 49 into the environment.

FIG. 5 shows a further exemplary embodiment. In this case a spiral-shaped conducting element 106 has been placed into the reservoir 61 and active carbon granules 110 have been used. This conducting element 106 should also be configured in such a manner that water cannot bypass the active carbon granules due to creep effects and exit the reservoir 61 without being cleaned. Alternatively, a plurality of reservoirs 61 can be contained in the module insert 4, through which water to be cleaned flows successively. Each of these reservoirs 61 can be structured differently in its interior as required.

1. A module insert comprising: at least one water level sensor, at least one valve, at least one flow channel for water and at least one reservoir with a sorbent mechanism configured to absorb impurities from the separated water,
wherein the sorbent mechanism is disposed in the reservoir and configured to extend a dwell time of separated water in the module insert.

2. The module insert according to claim 1,
further comprising at least one conducting element disposed inside the reservoir, and wherein the at least one conducting element extends the dwell time of the separated water in the module insert.

3. The module insert according to claim 1,
wherein the sorbent mechanism contains active carbon.

4. The module insert according to claim 2,
wherein the at least one conducting element consists of sorbent material.

5. The module insert according to of claim 4,
wherein the sorbent material is a textile configured to absorb fuel.

6. The module insert according to claim 3,
wherein the active carbon is configured as at least one of granules and a fibre material.

7. The module insert according to claim 6,
wherein the active carbon granules have a grain size of approximately 0.01 mm to 5 mm.

8. The module insert according to claim 1,
further comprising a displacer element in the at least one water-conducting flow channel, wherein the displacer element is an anti-freezing mechanism.

9. The module insert according to claim 1, further comprising at least two solenoid valves.

10. The module insert according to claim 1,
wherein the sorbent mechanism is at least one of a woven and nonwoven fabric configured to store fuel.

11. The module insert according to claim 1,
wherein the reservoir is a replaceable cleaning cartridge including the sorbent mechanism.

12. The module insert according to claim 1,
wherein the reservoir consists of plastic and is configured to store fuel.

13. The module insert according to claim 1, further comprising a heating system disposed in the at least one flow channel to prevent freezing at sub-zero temperatures.

14. A fuel filter comprising: a filter housing, a functional carrier, a lid, a filter element, inlet and outlet lines for the fuel and a module insert for installation in a liquid filter for cleaning the separated water.

15. The fuel filter according to claim 14, wherein the filter housing and a functional carrier together form inlet and outlet lines for the filter element.

16. The fuel filter according to claim 14, wherein the module insert includes at least one water level sensor, at least one valve, at least one flow channel for water, and at least one reservoir with a sorbent mechanism configured to absorb impurities from the separated water, wherein the sorbent mechanism is disposed in the reservoir and configured to extend a dwell time of the separated water in the module insert.

17. The fuel filter according to claim 16, wherein the module insert includes at least one conducting element disposed inside the reservoir, and further wherein the at least one conducting element extends the dwell time of the separated water in the module insert and the at least one conducting element consists of sorbent material.

18. The fuel filter according to claim 16, wherein the sorbent mechanism contains active carbon configured as granules having a grain size of approximately 0.01 mm to 5 mm.

19. The fuel filter according to claim 16, wherein the module insert includes at least two solenoid valves and a displacer element, the displacer element disposed in the at least one flow channel, wherein the displacer element is an anti-freezing mechanism.

20. The fuel filter according to claim 16, wherein the module insert includes a heating system disposed in the at least one flow channel to prevent freezing at sub-zero temperatures.
